(19) United States
(12) Patent Application Publication
(10) Pub. No.: US 2021/0241470 A1
(43) Pub. Date: Aug. 5, 2021

(54) IMAGE PROCESSING METHOD AND APPARATUS, ELECTRONIC DEVICE, AND STORAGE MEDIUM

(71) Applicant: BEIJING SENSETIME TECHNOLOGY DEVELOPMENT CO., LTD., Beijing (CN)

(72) Inventors: Xiaoou TANG, Beijing (CN); Xintao WANG, Beijing (CN); Zhuojie CHEN, Beijing (CN); Ke YU, Beijing (CN); Chao DONG, Beijing (CN); Chen Change LOY, Beijing (CN)

(21) Appl. No.: 17/236,023

(22) Filed: Apr. 21, 2021

Related U.S. Application Data
(63) Continuation of application No. PCT/CN2019/101458, filed on Aug. 19, 2019.

(30) Foreign Application Priority Data
Apr. 30, 2019 (CN) 201910361208.9

(51) Int. Cl. G06T 7/33; G06N 3/04; G06K 9/62; G06T 5/00

(52) U.S. Cl. CPC G06T 7/33; G06N 3/04; G06T 2207/20084; G06T 5/003; G06K 9/629; G06K 9/6289

(57) ABSTRACT

An image processing method includes: acquiring an image frame sequence, including a to-be-processed image frame and one or more image frames adjacent thereto, and performing image alignment on the to-be-processed image frame and each of image frames in the image frame sequence to obtain multiple pieces of aligned feature data; determining, based on the multiple pieces of alignment feature data, multiple similarity features each between a respective one of the multiple pieces of aligned feature data and aligned feature data corresponding to the to-be-processed image frame, and determining weight information of each of multiple pieces of aligned feature data based on the multiple similarity features; and fusing the multiple pieces of aligned feature data according to the weight information to obtain fusion information of the image frame sequence, the fusion information being configured to acquire a processed image frame corresponding to the to-be-processed image frame.

### CROSS-REFERENCE TO RELATED APPLICATIONS

This application is a continuation of International Application No. PCT/CN2019/101458, filed on Aug. 19, 2019, which claims priority to Chinese Patent Application No. 201910361208.9, filed on Apr. 30, 2019. The disclosures of International Application No. PCT/CN2019/101458 and Chinese Patent Application No. 201910361208.9 are hereby incorporated by reference in their entireties.

### BACKGROUND

Video restoration is a process of restoring high-quality output frames from a series of low-quality input frames. However, necessary information for restoring the high-quality frames has been lost in the low-quality frame sequence. Main tasks for video restoration include video super-resolution, video deblurring, video denoising and the like.

A procedure of video restoration usually includes four steps: feature extraction, multi-frame alignment, multi-frame fusion and reconstruction. Multi-frame alignment and multi-frame fusion are the key of a video restoration technology. For multi-frame alignment, an optical flow based algorithm is usually used at present, which consumes long time and has a poor effect. Consequently, the quality of multi-frame fusion based on alignment is also not so good enough, and errors in restoration may be produced.

### SUMMARY

The disclosure relates to the technical field of computer vision, and particularly to a method for image processing and device, an electronic device and a storage medium.

A method and device for image processing, an electronic device and a storage medium are provided in embodiments of the disclosure.

In a first aspect of embodiments of the disclosure, provided is a method for image processing, including: acquiring an image frame sequence, including an image frame to be processed and one or more image frames adjacent to the image frame to be processed, and performing image alignment on the image frame to be processed and each of image frames in the image frame sequence to obtain a plurality of pieces of aligned feature data; determining, based on the plurality of pieces of aligned feature data, a plurality of similarity features, each between a respective one of the plurality of pieces of aligned feature data and aligned feature data corresponding to the image frame to be processed, and determining, based on the plurality of similarity features, weight information of each of the plurality of pieces of aligned feature data; and fusing the plurality of pieces of aligned feature data according to the weight information of each of the plurality of pieces of aligned feature data, to obtain fused information of the image frame sequence, the fused information being configured to acquire a processed image frame corresponding to the image frame to be processed.

In a second aspect of embodiments of the disclosure, provided is a device for image processing, including an alignment module and a fusion module. The alignment module is configured to acquire an image frame sequence, including an image frame to be processed and one or more image frames adjacent to the image frame to be processed, and perform image alignment on the image frame to be processed and each of image frames in the image frame sequence to obtain a plurality of pieces of aligned feature data. The fusion module is configured to determine, based on the plurality of pieces of aligned feature data, a plurality of similarity features, each between a respective one of the plurality of pieces of aligned feature data and aligned feature data corresponding to the image frame to be processed, and determine, based on the plurality of similarity features, weight information of each of the plurality of pieces of aligned feature data. The fusion module is further configured to fuse the plurality of pieces of aligned feature data according to the weight information of each of the plurality of pieces of aligned feature data, to obtain fused information of the image frame sequence, the fused information being configured to acquire a processed image frame corresponding to the image frame to be processed.

In a third aspect of embodiments of the disclosure, provided is an electronic device, including a processor and a memory. The memory is configured to store instructions which, when being executed by the processor, cause the processor to carry out the following: acquiring an image frame sequence, including an image frame to be processed and one or more image frames adjacent to the image frame to be processed, and performing image alignment on the image frame to be processed and each of image frames in the image frame sequence to obtain a plurality of pieces of aligned feature data; determining, based on the plurality of pieces of aligned feature data, a plurality of similarity features, each between a respective one of the plurality of pieces of aligned feature data and aligned feature data corresponding to the image frame to be processed, and determining, based on the plurality of similarity features, weight information of each of the plurality of pieces of aligned feature data; and fusing the plurality of pieces of aligned feature data according to the weight information of each of the plurality of pieces of aligned feature data, to obtain fused information of the image frame sequence, the fused information being configured to acquire a processed image frame corresponding to the image frame to be processed.

In a fourth aspect of embodiments of the disclosure, provided is a non-transitory computer-readable storage medium, configured to store instructions which, when being executed by the processor, cause the processor to carry out the following: acquiring an image frame sequence, including an image frame to be processed and one or more image frames adjacent to the image frame to be processed, and performing image alignment on the image frame to be processed and each of image frames in the image frame sequence to obtain a plurality of pieces of aligned feature data; determining, based on the plurality of pieces of aligned feature data, a plurality of similarity features, each between a respective one of the plurality of pieces of aligned feature data and aligned feature data corresponding to the image frame to be processed, and determining, based on the plurality of similarity features, weight information of each of the plurality of pieces of aligned feature data; and fusing the plurality of pieces of aligned feature data according to the weight information of each of the plurality of pieces of aligned feature data, to obtain fused information of the image frame sequence, the fused information being configured to acquire a processed image frame corresponding to the image frame to be processed.

### BRIEF DESCRIPTION OF THE DRAWINGS

The accompanying drawings, which are incorporated in and constitute a part of this specification, illustrate embodiments consistent with the disclosure and, together with the specification, serve to describe the technical solutions of the disclosure.

FIG. 1 illustrates a schematic flowchart of a method for image processing according to embodiments of the disclosure.

FIG. 2 illustrates a schematic flowchart of another method for image processing according to embodiments of the disclosure.

FIG. 3 illustrates a schematic structural diagram of an alignment module according to embodiments of the disclosure.

FIG. 4 illustrates a schematic structural diagram of a fusion module according to embodiments of the disclosure.

FIG. 5 illustrates a schematic diagram of a video restoration framework according to embodiments of the disclosure.

FIG. 6 illustrates a schematic structural diagram of a device for image processing according to embodiments of the disclosure.

FIG. 7 illustrates a schematic structural diagram of another device for image processing according to embodiments of the disclosure.

FIG. 8 illustrates a schematic structural diagram of an electronic device according to embodiments of the disclosure.

### DETAILED DESCRIPTION

The technical solutions in the embodiments of the disclosure will be clearly and completely described below in conjunction with the drawings in the embodiments of the disclosure. It is apparent that the described embodiments are not all embodiments but only part of embodiments of the disclosure. All other embodiments obtained by those of ordinary skill in the art based on the embodiments in the disclosure without creative work shall fall within the scope of protection of the disclosure.

In the disclosure, the term “and/or” is only an association relationship describing associated objects and represents that three relationships may exist. For example, A and/or B may represent three conditions: i.e., independent existence of A, existence of both A and B, and independent existence of B. In addition, the term “at least one” in the disclosure represents any one of a plurality of objects, or any combination of at least two of a plurality of objects. For example, including at least one of A, B and C may represent including any one or more elements selected from a set formed by A, B and C. The terms “first”, “second” and the like in the specification, claims and drawings of the disclosure are used not to describe a specific sequence but to distinguish different objects. In addition, the terms “include/comprise” and “have” and any variants thereof are intended to cover nonexclusive inclusions. For example, a process, a method, a system, a product or a device including a series of steps or units is not limited to the steps or units which have been listed, but optionally further includes steps or units which are not listed or optionally further includes other steps or units intrinsic to the process, the method, the product or the device.

When “embodiment” is mentioned in the disclosure, it means that a specific feature, structure or characteristic described in combination with an embodiment may be included in at least one embodiment of the disclosure. This phrase appears at various positions in the specification does not always refer to the same embodiment, and may not be an independent or alternative embodiment mutually exclusive to another embodiment. It is explicitly and implicitly understood by those skilled in the art that the embodiments described in the disclosure may be combined with other embodiments.

A device for image processing involved in the embodiments of the disclosure is a device capable of image processing, and may be an electronic device, including a terminal device. During particular implementation, the terminal device includes, but not limited to, a mobile phone with a touch-sensitive surface (for example, a touch screen display and/or a touch pad), a laptop computer or other portable devices such as a tablet computer. It is also to be understood that, in some embodiments, the device is not a portable communication device but a desktop computer with a touch-sensitive surface (for example, a touch screen display and/or a touch pad).

The concept of deep learning in the embodiments of the disclosure originates from researches of artificial neural networks. A multilayer perceptron including a plurality of hidden layers is a deep learning structure. Deep learning combines features in a lower layer to form more abstract attribute class or features represented in a higher layer, to find a distributed feature representation of data.

Deep learning is a method of learning based on data representation in machine learning. An observation value (for example, an image) may be represented in many ways, for example, represented as a vector of an intensity value of each pixel, or represented more abstractly as a series of edges, a region in a specific shape, or the like. Use of some specific representation methods enables tasks (for example, facial recognition or facial expression recognition) of learning from instances more easily. An advantage of deep learning is that manual feature acquisition is replaced with an efficient algorithm of unsupervised or semi-supervised feature learning and layered feature extraction. Deep learning is a new field in researches of machine learning and has a motivation to establish a neural network that simulates a human brain for analysis and learning, and the mechanism of a human brain is imitated to interpret data such as an image, a sound and a text.

Like machine learning, deep machine learning is also divided to supervised learning and unsupervised learning. Learning models built under different learning frameworks are quite different. For example, a Convolutional Neural Network (CNN) is a machine learning model with deep supervised learning, may also be referred to as a deep learning based network structure model, and is a feedforward neural network containing convolutional calculation and having a deep structure, and is one of representative deep learning algorithms A Deep Belief Net (DBN) is a machine learning model with unsupervised learning.

The embodiments of the disclosure will be introduced below in detail.

According to the embodiments of the disclosure, an image frame sequence including an image frame to be processed and one or more image frames adjacent to the image frame to be processed are acquired, and image alignment is performed on the image frame to be processed and each of image frames in the image frame sequence to obtain a plurality of pieces of aligned feature data. Then, a plurality of similarity features, each between a respective one of the plurality of pieces of aligned feature data and aligned feature data corresponding to the image frame to be processed, are determined based on the plurality of pieces of aligned feature data, and weight information of each of the plurality of pieces of aligned feature data is determined based on the plurality of similarity features. The plurality of pieces of aligned feature data are fused according to the weight information of each of the plurality of pieces of aligned feature data. In such a manner, the fused information of the image frame sequence can be obtained. The fused information may be configured to acquire a processed image frame corresponding to the image frame to be processed. Therefore, the quality of multi-frame alignment and fusion in image processing may be greatly improved, and a display effect of the processed image may be improved; and moreover, image restoration and video restoration may be realized, and the accuracy of restoration and a restoration effect are enhanced.

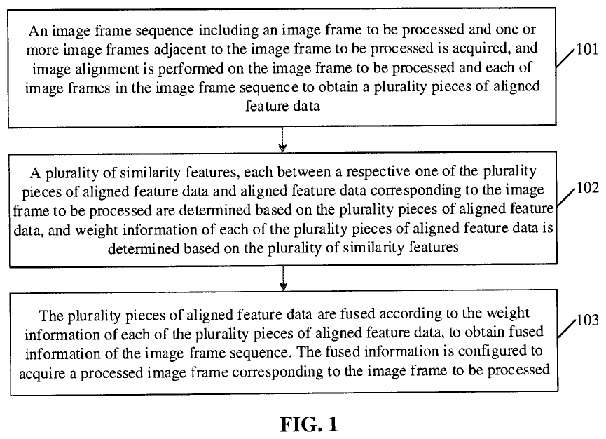

Referring to FIG. 1, FIG. 1 illustrates a schematic flowchart of a method for image processing according to embodiments of the disclosure. As illustrated in FIG. 1, the method for image processing includes the following steps.

In 101, an image frame sequence including an image frame to be processed and one or more image frames adjacent to the image frame to be processed is acquired, and image alignment is performed on the image frame to be processed and each of image frames in the image frame sequence to obtain a plurality of pieces of aligned feature data.

An execution subject of the method for image processing in the embodiments of the disclosure may be the abovementioned device for image processing. For example, the method for image processing may be executed by a terminal device or a server or other processing devices. The terminal device may be user equipment (UE), a mobile device, a user terminal, a terminal, a cell phone, a cordless phone, a personal digital assistant (PDA), a handheld device, a computing device, a vehicle-mounted device, a wearable device or the like. In some possible implementations, the method for image processing may be implemented by a processor calling computer-readable instructions stored in a memory.

The image frame may be a single frame of image, and may be an image acquired by an image acquisition device, for example, a photo taken by a camera of a terminal device, or a single frame of image in video data acquired by a video acquisition device. Particular implementation is not limited in the embodiments of the disclosure. At least two such image frames may form the image frame sequence. Image frames in video data may be sequentially arranged in a temporal order.

In the embodiments of the disclosure, a single frame of image is a still picture. Continuous frames of images produce an animation effect, and the continuous frames of images may form a video. Briefly, a frame rate generally refers to a frame number of pictures transmitted in one second, and may be understood as a number of refresh times that a graphics processing unit can implement in each second and is usually represented as Frames Per Second (FPS). A more smooth and realistic animation may be realized with a higher frame rate.

Image subsampling mentioned in the embodiments of the disclosure is a particular manner of image scaling-down and may also be referred to as downsampling. The image subsampling usually has two purposes: 1. to enable an image to be consistent with a size of a display region, and 2. to generate a subsampled image corresponding to the image.

Optionally, the image frame sequence may be an image frame sequence obtained by subsampling. That is to say, each video frame in an acquired video sequence may be subsampled to obtain the image frame sequence before image alignment is performed on the image frame to be processed and each of the image frames in the image frame sequence. For example, the subsampling step may be executed at first during image or video super-resolution, and the subsampling operation may not be necessary for image deblurring.

During alignment of image frames, at least one image frame needs to be selected as a reference frame for alignment, and the other image frames in the image frame sequence other than the reference frame and the reference frame itself are aligned to the reference frame. For convenient description, the reference frame is referred to as an image frame to be processed in the embodiments of the disclosure, and the image frame sequence is formed by the image frame to be processed and one or more image frames adjacent to the image frame to be processed.

When the word “adjacent” is used, it may refer to “immediately adjacent to”, or may refer to “spaced apart from”. If the image frame to be processed is denoted as t, the image frame adjacent thereto may be denoted as t−i or t+i. For example, in an image frame sequence, arranged in a temporal order, of video data, an image frame adjacent to an image frame to be processed may be a former frame and/or latter frame of the image frame to be processed, or may be such as a second frame counting backwards and/or forwards starting from the image frame to be processed. There may be one, two, three or more frames adjacent to the image frame to be processed, and the embodiments of the disclosure do not set limitations herein.

In an optional embodiment of the disclosure, image alignment may be performed on the image frame to be processed and each of image frames in the image frame sequence. That is to say, image alignment is performed on each image frame (it is to be noted that the image to be processed may be included) in the image frame sequence and the image frame to be processed, to obtain the plurality of pieces of aligned feature data.

In an optional implementation, the operation that image alignment is performed on the image frame to be processed and each of the image frames in the image frame sequence to obtain the plurality of pieces of aligned feature data includes that: image alignment may be performed on the image frame to be processed and each of the image frames in the image frame sequence based on a first image feature set and one or more second image feature sets, to obtain the plurality of pieces of aligned feature data. The first image feature set includes at least one piece of feature data of the image frame to be processed, and each of the at least one piece of feature data in the first image feature set has a respective different scale. Each of the one or more second image feature sets includes at least one piece of feature data of a respective image frame in the image frame sequence, and each of the at least one piece of feature data in the second image feature set has a respective different scale.

Performing image alignment on image features of different scales to obtain the aligned feature data may solve problems about alignment in video restoration and improve the accuracy of multi-frame alignment, particularly in the case that there is a complex motion or a motion with a relatively large magnitude, occlusion and/or blur in an input image frame.

As an example, for an image frame in the image frame sequence, feature data corresponding to the image frame may be obtained through feature extraction. Based on this, at least one piece of feature data of the image frame in the image frame sequence may be obtained to form an image feature set, and each of the at least one piece of feature data has a respective different scale.

Convolution may be performed on the image frame to obtain the feature data of different scales of the image frame. The first image feature set may be obtained by performing feature extraction (i.e., convolution) on the image frame to be processed. A second image feature set may be obtained by performing feature extraction (i.e., convolution) on the image frame in the image frame sequence.

In the embodiments of the disclosure, at least one piece of feature data, each of a respective scale, may be obtained for each image frame. For example, a second image feature set may include at least two pieces of feature data, each of a respective difference scale, corresponding to an image frame, and the embodiments of the disclosure do not set limitations herein.

For convenient description, the at least one piece of feature data (which may be referred to as first feature data), each of a different scale, of the image frame to be processed forms the first image feature set. The at least one piece of feature data (which may be referred to as second feature data) of the image frame in the image frame sequence forms the second image feature set, and each of the at least one piece of feature data has a respective different scale. Since the image frame sequence may include a plurality of image frames, a plurality of second image feature sets may be formed corresponding to respective ones of the plurality of image frames. Further, image alignment may be performed based on the first image feature set and one or more second image feature sets.

As an implementation, the plurality of pieces of aligned feature data may be obtained by performing image alignment based on all the second image feature sets and the first image feature set. That is, alignment is performed on the image feature set corresponding to the image frame to be processed and the image feature set corresponding to each image frame in the image frame sequence, to obtain a respective one of the plurality of pieces of aligned feature data. Moreover, it is to be noted that alignment of the first image feature set with the first image feature set is also included. A specific approach for performing image alignment based on the first image feature set and the one or more second image feature sets are described hereinafter.

In an optional implementation, the feature data in the first image feature set and the second image feature set may be arranged in a pyramid structure in a small-to-large order of scales.

An image pyramid involved in the embodiments of the disclosure is one of multi-scale representations of an image, and is an effective but conceptually simple structure which interprets an image with a plurality of resolutions. A pyramid of an image is a set of images with gradually decreasing resolutions which are arranged in a pyramid form and originate from the same original image. The image feature data in the embodiments of the disclosure may be obtained by strided downsampling convolution until a certain stop condition is satisfied. The image feature data in layers is compared to a pyramid, and a higher layer corresponds to a smaller scale.

A result of alignment between the first feature data and the second feature data in the same scale may further be used for reference and adjustment during image alignment in another scale. By performing alignment layer by layer at different scales, the aligned feature data of the image frame to be processed and any image frame in the image frame sequence may be obtained. The alignment process may be executed on each image frame and the image frame to be processed, thereby obtaining the plurality of pieces of aligned feature data. The number of pieces of the aligned feature data obtained is consistent with the number of the image frames in the image frame sequence.

In an optional embodiment of the disclosure, the operation that image alignment is performed on the image frame to be processed and each of the image frames in the image frame sequence based on the first image feature set and the one or more second image feature sets to obtain the plurality of pieces of aligned feature data may include the following. Action a), first feature data of a smallest scale in the first image feature set is acquired, and second feature data, of the same scale as the first feature data, in one of the one or more second image feature sets is acquired. Action b), image alignment is performed on the first feature data and the second feature data to obtain first aligned feature data. Action c), third feature data of a second smallest scale in the first image feature set is acquired, and fourth feature data, of the same scale as the third feature data, in the second image feature set is acquired. Action d), upsampling convolution is performed on the first aligned feature data to obtain the first aligned feature data having the same scale as that of the third feature data. Action e), image alignment is performed, based on the first aligned feature data having subjected to the upsampling convolution, on the third feature data and the fourth feature data to obtain second aligned feature data. In action f), the preceding actions a)-e) are executed in a small-to-large order of scales until a piece of aligned feature data of the same scale as the image frame to be processed is obtained. In action g), the preceding actions a)-f) are executed based on all the second image feature sets to obtain the plurality of pieces of aligned feature data.

For any number of input image frames, a direct objective is to align one of the frames according to another one of the frames. The process is mainly described with the image frame to be processed and any image frame in the image frame sequence, namely image alignment is performed based on the first image feature set and any second image feature set. Specifically, the first feature data and the second feature data may be sequentially aligned starting from the smallest scale.

As an example, the feature data of each image frame may be aligned at a smaller scale, and then scaled up (which may be implemented by the upsampling convolution) for alignment at a relatively larger scale. The plurality of pieces of aligned feature data may be obtained, by performing the above alignment processing on the image frame to be processed and each image frame in the image frame sequence. In the process, an alignment result in each layer may be scaled up by the upsampling convolution, and then input to an upper layer (at a larger scale) for aligning the first feature data and second feature data of this larger scale. By means of the layer-by-layer alignment and adjustment, the accuracy of image alignment may be improved, and image alignment tasks under complex motions and blurred conditions may be completed better.

The number of alignment times may depend on the number of pieces of feature data of the image frame. That is, alignment operation may be executed until aligned feature data of the same scale as the image frame to be processed is obtained. The plurality of pieces of aligned feature data may be obtained by executing the above steps based on all the second image feature sets. That is, the image feature set corresponding to the image frame to be processed and the image feature set corresponding to each image frame in the image frame sequence are aligned according to the description, to obtain the plurality pieces of corresponding aligned feature data. Moreover, it is to be noted that alignment of the first image feature set with the first image feature set itself is also included. The scale of the feature data and the number of different scales are not limited in the embodiments of the disclosure, namely the number of layers (times) that the alignment operation is performed is also not limited.

In an optional embodiment of the disclosure, after obtaining the plurality of pieces of aligned feature data, each of the plurality of pieces of aligned feature data may be adjusted based on a deformable convolutional network (DCN) to obtain a plurality pieces of adjusted aligned feature data.

In an optional implementation, each piece of aligned feature data is adjusted based on the DCN, to obtain the plurality pieces of adjusted aligned feature data. After the pyramid structure, the obtained aligned feature data may be further adjusted by an additionally cascaded DCN. The alignment result is further adjusted finely based on a multi-frame alignment in the embodiments of the disclosure, so that the accuracy of image alignment may be further improved.

In 102, a plurality of similarity features, each between a respective one of the plurality of pieces of aligned feature data and aligned feature data corresponding to the image frame to be processed are determined based on the plurality of pieces of aligned feature data, and weight information of each of the plurality of pieces of aligned feature data is determined based on the plurality of similarity features.

Calculation of image similarity is mainly executed to score a similarity between contents of two images, the similarity between the contents of the images may be judged according to a score. In the embodiments of the disclosure, calculation of the similarity feature may be implemented through a neural network. Optionally, an image feature point based image similarity algorithm may be used. Alternatively, an image may be abstracted into a plurality of feature values, for example, through a Trace transform, image hash or a Sift feature vector, and then feature matching is performed according to the aligned feature data to improve the efficiency, and the embodiments of the disclosure do not set limitations herein.

In an optional implementation, the operation that the plurality of similarity features, each between a respective one of the plurality of pieces of aligned feature data and the aligned feature data corresponding to the image frame to be processed are determined based on the plurality of pieces of aligned feature data includes that: a dot product operation may be performed on each of the plurality of pieces of aligned feature data and the aligned feature data corresponding to the image frame to be processed, to determine the plurality of similarity features, each between a respective one of the plurality of pieces of aligned feature data and the aligned feature data corresponding to the image frame to be processed.

The weight information of each of the plurality of pieces of aligned feature data may be determined through the plurality of similarity features, each between a respective one of the plurality of pieces of aligned feature data and the aligned feature data corresponding to the image frame to be processed. The weight information may represent different importance of different frames in all the aligned feature data. It can be understood that the importance of different image frames is determined according to similarities thereof with the image frame to be processed.

It can usually be understood that, if the similarity is higher, the weight is greater. It indicates that, as feature information that can be provided during alignment by an image frame and the image frame to be processed is overlapped with each other to a greater extent, the image frame is more important to subsequent multi-frame fusion.

In an optional implementation, the weight information of the aligned feature data may include a weight value. The weight value may be calculated using a preset algorithm or a preset neural network based on the aligned feature data. For any two pieces of aligned feature data, the weight information may be calculated by means of a dot product of vectors. Optionally, the weight value in a preset range may be obtained by calculation. If a weight value is higher, it is usually indicated that the aligned feature data is more important among all the frames, namely needs to be reserved. If the weight value is lower, it is indicated that the aligned feature data is less important among all the frames, may contain an error, an occluded element, or a poor effect in an alignment stage relative to the image frame to be processed, and may be ignored, and the embodiments of the disclosure do not set limitations herein.

In the embodiments of the disclosure, multi-frame fusion may be implemented based on an attention mechanism. The attention mechanism described in the embodiments of the disclosure originates from researches on human vision. In the cognitive science, due to bottlenecks in information processing, a person may selectively pay attention to part of all information and ignore other visible information in the meantime. Such a mechanism is referred to as the attention mechanism. Different parts of a human retina have different information processing capabilities, i.e., acuities, and only a central concave part of the retina has the highest acuity. For reasonably utilizing finite visual information processing resources, a person needs to select a specific part in a visual region and then focus on it. For example, when reading, only a small number of words to be read will be paid attention to and processed by the person. From the above, the attention mechanism mainly lies in two aspects: deciding which part of an input requires attention and allocating finite information processing resources to an important part.

An inter-frame temporal relationship and an intra-frame spatial relationship are vitally important for multi-frame fusion. Because different adjacent frames have different amounts of information due to problems of occlusion, blurred regions, parallax or the like, and dislocation and misalignment that may be produced in the previous multi-frame alignment stage have negative influence on performance of subsequent reconstruction. Therefore, dynamic aggregation of adjacent frames in a pixel level is essential for effective multi-frame fusion. In the embodiments of the disclosure, an objective of a temporal attention is to calculate a similarity between frames embedded in a space. Explicitly, for each piece of aligned feature data, more attention should also be paid to an adjacent frame thereof. By means of the temporal and spatial attention mechanism based multi-frame fusion, different information contained in different frames may be dug out, and the problem that difference between information contained in a plurality of frames is not considered in a general multi-frame fusion solution may be improved.

After the weight information of each of the plurality of pieces of aligned feature data is determined, step 103 may be executed.

In 103, the plurality of pieces of aligned feature data are fused according to the weight information of each of the plurality of pieces of aligned feature data, to obtain fused information of the image frame sequence. The fused information is configured to acquire a processed image frame corresponding to the image frame to be processed.

The plurality of pieces of aligned feature data are fused according to the weight information of each of the plurality of pieces of aligned feature data, so that differences and importance of the aligned feature data of different image frames are considered. Proportions of the aligned feature data during fusion may be adjusted according to the weight information. Therefore, problems in multi-frame fusion can be effectively solved, different information contained in different frames may be dug out, and imperfect alignment occurred in a previous alignment stage may be corrected.

In an optional implementation, the operation that the plurality of pieces of aligned feature data are fused according to the weight information of each of the plurality of pieces of aligned feature data to obtain the fused information of the image frame sequence includes that: the plurality of pieces of aligned feature data are fused by a fusion convolutional network according to the weight information of each of the plurality of pieces of aligned feature data, to obtain the fused information of the image frame sequence.

In an optional implementation, the operation that the plurality of pieces of aligned feature data are fused by the fusion convolutional network according to the weight information of each of the plurality of pieces of aligned feature data, to obtain the fused information of the image frame sequence includes that: each of the plurality of pieces of aligned feature data is multiplied by a respective piece of weight information through element-wise multiplication, to obtain a plurality pieces of modulated feature data, each for a respective one of the plurality of pieces of aligned feature data; and the plurality pieces of modulated feature data are fused by the fusion convolutional network to obtain the fused information of the image frame sequence.

A temporal attention (namely the weight information above) map is correspondingly multiplied by the aforementioned obtained aligned feature data in a pixel-wise manner The aligned feature data modulated by the weight information is referred to as the modulated feature data. Then, the plurality pieces of modulated feature data are aggregated by the fusion convolutional network to obtain the fused information of the image frame sequence.

In an optional embodiment of the disclosure, the method further includes that: the processed image frame corresponding to the image frame to be processed is acquired according to the fused information of the image frame sequence.

Through the method, the fused information of the image frame sequence can be obtained, and image reconstruction may further be performed according to the fused information to obtain the processed image frame corresponding to the image frame to be processed. A high-quality frame may usually be restored, and image restoration is realized. Optionally, such image processing may be performed on a plurality of image frames to be processed, to obtain a processed image frame sequence including a plurality of processed image frames. The plurality of processed image frames may form video data, to achieve an effect of video restoration.

In the embodiments of the disclosure, a unified framework capable of effectively solving multiple problems in video restoration, including, but not limited to, video super-resolution, video deblurring and video denoising is provided. Optionally, the method for image processing proposed in the embodiments of the disclosure is generic, may be applied to many image processing scenarios such as alignment of a facial image, and may also be combined with other technologies involving video data processing and image processing, and the embodiments of the disclosure do not set limitations herein.

It can be understood by those skilled in the art that, in the above method of the detailed description, the sequence in which various steps are drafted does not mean a strict sequence of execution and is not intended to form any limitation to the implementation. A particular sequence of executing various steps should be determined by functions and probable internal logic thereof.

In the embodiments of the disclosure, an image frame sequence including an image frame to be processed and one or more image frames adjacent to the image frame to be processed may be acquired, and image alignment may be performed on the image frame to be processed and each of image frames in the image frame sequence to obtain a plurality of pieces of aligned feature data. Then a plurality of similarity features, each between a respective one of the plurality of pieces of aligned feature data and aligned feature data corresponding to the image frame to be processed may be determined based on the plurality of pieces of aligned feature data, and weight information of each of the plurality of pieces of aligned feature data may be determined based on the plurality of similarity features. By fusing the plurality of pieces of aligned feature data according to the weight information of each of the plurality of pieces of aligned feature data, fused information of the image frame sequence can be obtained. The fused information may be configured to acquire a processed image frame corresponding to the image frame to be processed.

Alignment at different scales improves the accuracy of image alignment. In addition, the differences between and importance of the aligned feature data of different image frames are considered during weight information based multi-frame fusion, so that the problems in multi-frame fusion may be effectively solved, different information contained in different frames may be dug out, and imperfect alignment occurred in a previous alignment stage may be corrected. Therefore, the quality of multi-frame alignment and fusion in image processing may be greatly improved, and a display effect of a processed image may be increased. Moreover, image restoration and video restoration may be realized, and the accuracy of restoration and a restoration effect are improved.

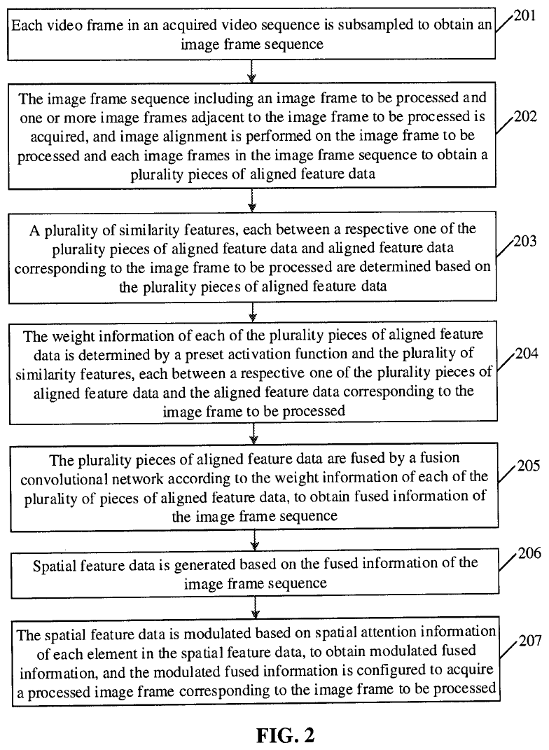

Referring to FIG. 2, FIG. 2 illustrates a schematic flowchart of another method for image processing according to embodiments of the disclosure. An execution subject of the steps of the embodiments of the disclosure may be the abovementioned device for image processing. As illustrated in FIG. 2, the method for image processing includes the following steps.

In 201, each video frame in an acquired video sequence is subsampled to obtain an image frame sequence.

The execution subject of the method for image processing in the embodiments of the disclosure may be the abovementioned device for image processing. For example, the method for image processing may be executed by a terminal device or a server or another processing device. The terminal device may be user equipment (UE), a mobile device, a user terminal, a terminal, a cell phone, a cordless phone, a personal digital assistant (PDA), a handheld device, a computing device, a vehicle device, a wearable device or the like. In some possible implementations, the method for image processing may be implemented by a processor calling computer-readable instructions stored in a memory.

The image frame may be a single frame of image, and may be an image acquired by an image acquisition device, for example, a photo taken by a camera of a terminal device, or a single frame of image in video data acquired by a video acquisition device and capable of forming the video sequence. Particular implementation is not limited in the embodiments of the disclosure. An image frame of a lower resolution can be obtained through the subsampling, facilitating improving the accuracy of subsequent image alignment.

In an optional embodiment of the disclosure, a plurality of image frames in the video data may be sequentially extracted at a preset time interval to form the video sequence. The number of the extracted image frames may be a preset number, and may usually be an odd number, for example, 5, such that one of the frames may be selected as an image frame to be processed, for an alignment operation. The video frames truncated from the video data may be sequentially arranged in a temporal order.

Similar to the embodiments illustrated in FIG. 1, for feature data obtained after feature extraction is performed on the image frame, in a pyramid structure, subsampling convolution may be performed on feature data of an (L−1)^{th} layer by a convolutional filter to obtain feature data of an L^{th} layer. For the feature data of the L^{th} layer, alignment prediction may be performed by the feature data of an upper (L+1)^{th} layer. However, upsampling convolution needs to be performed on the feature data of the upper (L+1)^{th} layer before the prediction, so that the feature data of the upper (L+1)^{th} layer has the same scale as the feature data of the L^{th} layer.

In an optional implementation, a three-layer pyramid structure may be used, namely L=3. The implementation is given as an example for reducing the calculation cost. Optionally, the number of channels may also be increased along with reduction of a space size, and the embodiments of the disclosure do not set limitations herein.

In 202, the image frame sequence including an image frame to be processed and one or more image frames adjacent to the image frame to be processed is acquired, and image alignment is performed on the image frame to be processed and each of image frames in the image frame sequence to obtain a plurality of pieces of aligned feature data.

For any two input image frames, a direct objective is to align one of the frames according to the other one of the frames. At least one image frame may be selected from the image frame sequence as a reference image frame to be processed, and a first feature set of the image frame to be processed is aligned with a feature set of each image frame in the image frame sequence, to obtain the plurality of pieces of aligned feature data. For example, the number of the extracted image frames may be 5, such that the 3^{rd} frame in the middle may be selected as an image frame to be processed, for the alignment operation. Furthermore, for example, during practical application, for the video data, i.e., the image frame sequence including a plurality of video frames, 5 continuous image frames may be extracted at the same time interval, and a middle one of each five image frames serves as a reference frame for alignment of the five image frames, i.e., an image frame to be processed in the sequence.

A method for multi-frame alignment in step 202 may refer to step 102 in the embodiments illustrated in FIG. 1 and will not be elaborated herein.

As an example, details of the pyramid structure, a sampling process and alignment are mainly described in step 102. For example, an image frame X is taken as an image frame to be processed, and feature data a and feature data b of different scales are obtained for the image frame X. The scale of a is smaller than the scale of b, namely a may be in a layer lower than b in the pyramid structure. For convenient description, an image frame Y (which may also be the image frame to be processed) in the image frame sequence is selected. Feature data obtained by performing same processing on Y may include feature data c and feature data d of different scales. The scale of c is smaller than the scale of d. a and c have same scale, and b and d have same scale. In such case, a and c of a smaller scale may be aligned to obtain aligned feature data M, then upsampling convolution is performed on the aligned feature data M to obtain scaled-up aligned feature data M, for alignment of b and d in a larger scale. Aligned feature data N may be obtained in the layer where b and d are located. Similarly, for all the image frames in the image frame sequence, the abovementioned alignment process may be executed on each image frame to obtain the aligned feature data of the plurality of image frames relative to the image frame to be processed. For example, there are 5 image frames in the image frame sequence, 5 pieces of aligned feature data having been aligned based on the image frame to be processed may be obtained respectively. That is, an alignment result of the image to be processed itself is included.

In an optional implementation, the alignment operation may be implemented by an alignment module with a Pyramid structure, Cascading and Deformable convolution, and may be referred to as a PCD alignment module.

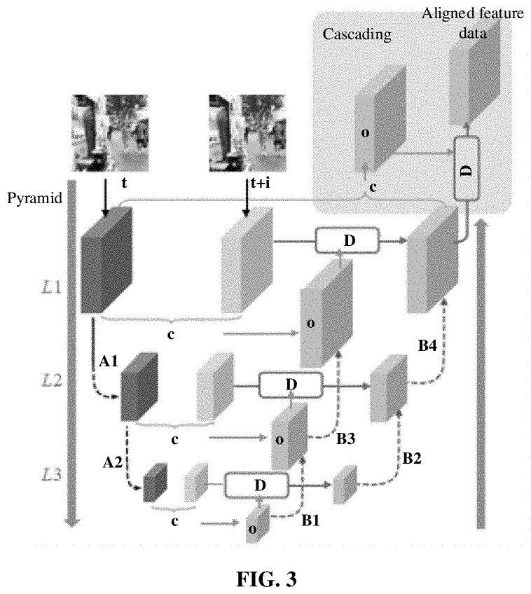

For example, a schematic diagram of alignment structure as illustrated in FIG. 3 may be referred to. FIG. 3 illustrates an exquisite schematic diagram of the pyramid structure and cascading used in alignment in the method for image processing. Images t and t+i represent input image frames.

As illustrated by the dashed lines A1 and A2 in FIG. 3, subsampling convolution may be performed on a feature of the (L−1)^{th} layer by the convolutional filter, to obtain a feature of the L^{th} layer. For the L^{th} layer, an offset o and an aligned feature may also be predicted through an offset o and aligned feature, having subjected to upsampling convolution, of the upper (L+1)^{th} layer (as the dashed lines B1 to B4 in FIG. 3). The following expression (1) and expression (2) may be referred to:

ΔPₜ₊ᵢ^{l}=f([Fₜ₊ᵢ, Fₜ],(ΔPₜ₊ᵢ^{l+1})^{↑2}) (1)

(Fₜ₊ᵢ^{a})^{l}=g(DConv(Fₜ₊ᵢ^{l},ΔPₜ₊ᵢ^{l}),((Fₜ₊ᵢ^{a})^{l+1})^{↑2}) (2)

Unlike an optical flow based method, deformable alignment, represented as Fₜ₊₁, i∈[−N:+N], is performed on a feature of each frame in the embodiments of the disclosure. It can be understood that Fₜ₊ᵢ represents feature data of the image frame t+i and Fₜ represents feature data of the image t that is usually considered as the image frame to be processed. ΔPₜ₊ᵢ^{l} and ΔPₜ₊ᵢ^{l+1} are the offsets of the L^{th} layer and the (L+1)^{th} layer respectively. (Fₜ₊ᵢ^{a})^{l} and (Fₜ₊ᵢ^{a})^{l+1} are the aligned feature data of the L^{th} layer and the (L+1)^{th} layer respectively. (⋅)^{↑s} refers to increasing by a factor of s, DConv refers to deformable convolution D, g is a generic function with multiple convolutional layers, and ×2 upsampling convolution may be realized by bilinear interpolation. In the schematic diagram, a three-layer pyramid is used, namely L=3.

c in the drawing may be understood as a concatenation (concat) function for combination of matrixes and splicing of images.

Additional deformable convolution (the part with shaded background in FIG. 3) for alignment adjustment may be cascaded after the pyramid structure to further refine preliminarily aligned features. In such a coarse-to-fine manner, the PCD alignment module may improve image alignment in a sub-pixel level.

The PCD alignment module may learn together with the whole network framework without additional supervision or pre-training another task such as an optical flow.

In an optional embodiment of the disclosure, in the method for image processing in the embodiments of the disclosure, the functions of the alignment module may be set and adjusted according to different tasks. An input of the alignment module may be a subsampled image frame, and the alignment module may directly execute alignment in the method for image processing. Alternatively, subsampling may be executed before alignment is performed in the alignment module. That is, the input of the alignment module is firstly subsampled, and alignment is performed on the subsampled image frame. For example, image or video super-resolution may be the former situation described above, and video deblurring and video denoising may be the latter situation described above, and the embodiments of the disclosure do not set limitations herein.

In an optional embodiment of the disclosure, before the alignment is performed, the method further includes that: deblurring is performed on the image frames in the image frame sequence.

Different processing methods are usually required for image blurring caused by different reasons. Deblurring in the embodiments of the disclosure may be any approach for image enhancement, image restoration and/or super-resolution reconstruction. By deblurring, alignment and fusion processing may be implemented more accurately in the method for image processing in the disclosure.

In 203, a plurality of similarity features, each between a respective one of the plurality of pieces of aligned feature data and aligned feature data corresponding to the image frame to be processed are determined based on the plurality of pieces of aligned feature data.

Step 203 may refer to the specific descriptions about step 102 in the embodiments illustrated in FIG. 1 and will not be elaborated herein.

In 204, the weight information of each of the plurality of pieces of aligned feature data is determined by a preset activation function and the plurality of similarity features, each between a respective one of the plurality of pieces of aligned feature data and the aligned feature data corresponding to the image frame to be processed.

The activation function involved in the embodiments of the disclosure is a function running at a neuron of an artificial neural network and is responsible for mapping an input of the neuron to an output end. The activation function introduces a nonlinear factor to the neuron in the neural network such that the neural network may approximate any nonlinear function, such that the neural network may be applied to many nonlinear models. Optionally, the preset activation function may be a Sigmoid function.

The Sigmoid function is a common S-shaped function in biology, and is also referred to as an S-growth curve. In information science, due to the properties such as monotonic increase thereof and monotonic increase of an inverse function thereof, the Sigmoid function is usually used as a threshold function for the neural network to map a variable to a range of 0 to 1.

In an optional implementation, for each input frame i∈[−n:+n], a similarity distance h may be taken as the weight information for reference, and h may be determined through the following expression (3):

h(Fₜ₊ᵢ^{a},Fₜ^{a})=sigmoid(θ(Fₜ₊ᵢ^{a})^{T}φ(Fₜ^{a})) (3)

θ(Fₜ₊ᵢ^{a}) and φ(Fₜ^{a}) may be understood as two embeddings and may be realized by a simple convolutional filter. The Sigmoid function is used to limit an output result to be within a range of [0, 1], namely a weight value may be a numeric value from 0 to 1 and is implemented based on gradient-stable back propagation. Modulating the aligned feature data by use of the weight value may be performing judgment through two preset threshold values, and a range of the preset threshold values may be (0, 1). For example, the aligned feature data of which the weight value is less than the preset threshold value may be ignored, and the aligned feature data of which the weight value is greater than the preset threshold value is reserved. That is, the aligned feature data is screened and the importance thereof is represented according to the weight values, to facilitate reasonable multi-frame fusion and reconstruction.

Step 204 may also refer to the specific description about step 102 in the embodiments illustrated in FIG. 1 and will not be elaborated herein.

After the weight information of each of the plurality of pieces of aligned feature data is determined, step 205 may be executed.

In 205, the plurality of pieces of aligned feature data are fused by a fusion convolutional network according to the weight information of each of the plurality of pieces of aligned feature data, to obtain fused information of the image frame sequence.

The fused information of the image frames may be understood as information of the image frames at different spatial positions and different feature channels.

In an optional implementation, the operation that the plurality of pieces of aligned feature data are fused by the fusion convolutional network according to the weight information of each of the plurality of pieces of aligned feature data, to obtain the fused information of the image frame sequence includes that: each of the plurality of pieces of aligned feature data is multiplied by a respective piece of weight information through element-wise multiplication, to obtain a plurality pieces of modulated feature data, each for a respective one of the plurality of pieces of aligned feature data; and the plurality pieces of modulated feature data are fused by the fusion convolutional network, to obtain the fused information of the image frame sequence.

The element-wise multiplication may be understood as a multiplication operation accurate to pixels in the aligned feature data. Feature modulation may be performed by: multiplying each pixel in the aligned feature data by corresponding weight information of the aligned feature data, to obtain the plurality pieces of modulated feature data respectively.

Step 205 may also refer to the specific description about step 103 in the embodiments illustrated in FIG. 1 and will not be elaborated herein.

In step 206, spatial feature data is generated based on the fused information of the image frame sequence.

Feature data in a space, i.e., the spatial feature data, may be generated based on the fused information of the image frame sequence, and may specifically be a spatial attention mask.

In the embodiments of the disclosure, a mask used in image processing may be configured to extract a region of interest: a region-of-interest mask made in advance is multiplied by an image to be processed, to obtain a region-of-interest image. An image value in the region of interest is kept unchanged, and an image value outside the region is 0. The mask may further be used for blocking: some regions in the image are blocked by the mask and thus do not participate in processing or calculation of a processing parameter, or only the blocked regions are processed or made statistics about.

In an optional embodiment of the disclosure, the design of the pyramid structure may still be used, so as to enlarge a receptive field of spatial attention.

In step 207, the spatial feature data is modulated based on spatial attention information of each element in the spatial feature data, to obtain modulated fused information, and the modulated fused information is configured to acquire a processed image frame corresponding to the image frame to be processed.

As an example, the operation that the spatial feature data is modulated based on the spatial attention information of each element in the spatial feature data to obtain the modulated fused information includes that: each element in the spatial feature data is modulated by element-wise multiplication and addition according to respective spatial attention information of the element in the spatial feature data, to obtain the modulated fused information.

The spatial attention information represents a relationship between a spatial point and a point around. That is to say, the spatial attention information of each element in the spatial feature data represents a relationship between the element in the spatial feature data and an element around, and similar to the weight information in space, may reflect the importance of the element.

Based on a spatial attention mechanism, each element in the spatial feature data may be correspondingly modulated by element-wise multiplication and addition according to the spatial attention information of the element in the spatial feature data.

In the embodiment, each element in the spatial feature data may be correspondingly modulated by element-wise multiplication and addition according to the spatial attention information of the element in the spatial feature data, thereby obtaining the modulated fused information.

In an optional implementation, the fusion operation may be implemented by a fusion module with temporal and spatial attention, which may be referred to as a TSA fusion module.

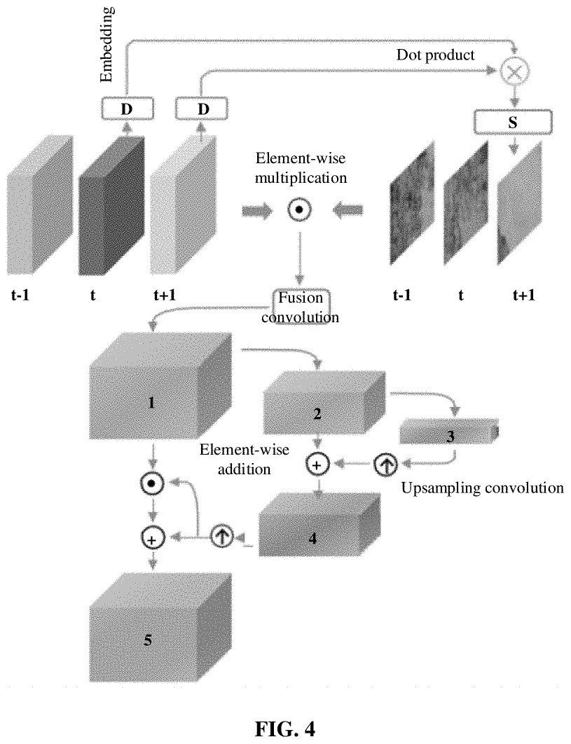

As an example, the schematic diagram of multi-frame fusion illustrated in FIG. 4 may be referred to. A fusion process illustrated in FIG. 4 may be executed after the alignment module illustrated in FIGS. 3. t−1, t and t+1 represent features of three continuously adjacent frames respectively, i.e., the obtained aligned feature data. D represents deformable convolution, and S represents the Sigmoid function. For example, for the feature t+1, weight information t+1 of the feature t+1 relative to the feature t may be calculated by deformable convolution D and a dot product operation. Then, the weight information (temporal attention information) map is multiplied by original aligned feature data Fₜ₊ᵢ^{a} in a pixel-wise manner (element-wise multiplication). For example, the feature t+1 is correspondingly modulated by use of the weight information t+1. The modulated aligned feature data \tilde{F}ₜ₊ᵢ^{a} may be aggregated by use of the fusion convolutional network illustrated in the drawing, and then the spatial feature data, which may be the spatial attention mask, may be calculated according to fused feature data. After that, the spatial feature data may be modulated by element-wise multiplication and addition based on the spatial attention information of each pixel therein, and the modulated fused information may finally be obtained.

Exemplary description is further made with the example in step 204, and the fusion process may be represented as:

\tilde{F}ₜ₊ᵢ^{a}=Fₜ₊ᵢ^{a}●h(Fₜ₊ᵢ^{a},Fₜ^{a}) (4)

F_{fusion}=Conv([F_{t-N}^{a}, . . . , Fₜ^{a}, . . . , F_{t+N}^{a}]) (5)

● and [⋅, ⋅, ⋅] represent element-wise multiplication and cascading respectively.

A pyramid structure is used for modulation of the spatial feature data in FIG. 4. Referring to cubes 1 to 5 in the drawing, subsampling convolution is performed twice on obtained spatial feature data 1 to obtain two pieces of spatial feature data 2 and 3 of smaller scales respectively. Then element-wise addition is performed on the smallest spatial feature data 3 having subjected to upsampling convolution and the spatial feature data 2, to obtain spatial feature data 4 of the same scale as the spatial feature data 2. Element-wise multiplication is performed on the spatial feature data 4 having subjected to upsampling convolution and the spatial feature data 1, and element-wise addition is performed on an obtained result of the element-wise multiplication and the spatial feature data 4 having subjected to upsampling convolution to obtain spatial feature data 5 of the same scale as the spatial feature data 1, i.e., the modulated fused information.

The number of layers in the pyramid structure is not limited in the embodiments of the disclosure. The method is implemented on spatial features of different scales, so that information at different spatial positions may further be dug out to obtain fused information which has higher quality and is more accurate.

In an optional embodiment of the disclosure, image reconstruction may be performed according to the modulated fused information to obtain the processed image frame corresponding to the image frame to be processed. A high-quality frame may usually be restored, and image restoration is realized.

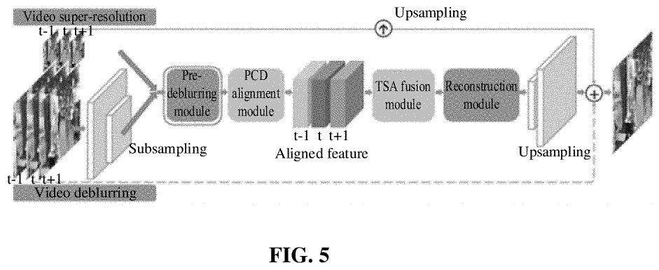

After image reconstruction is performed on the fused information to obtain the high-quality frame, image upsampling may further be performed to restore the image to the same size as that before processing. In the embodiments of the disclosure, a main objective of image upsampling, or referred to as image interpolation, is to scale up the original image for displaying with a higher resolution, and the aforementioned upsampling convolution is mainly intended for changing the scales of the image feature data and the aligned feature data. Optionally, the upsampling may be performed in many ways, for example, nearest neighbor interpolation, bilinear interpolation, mean interpolation and median interpolation, and the embodiments of the disclosure do not set limitations herein. FIG. 5 and the related description thereof may be referred to for particular application.

In an optional implementation, in the case that a resolution of an image frame sequence in a first video stream acquired by the video acquisition device is smaller than or equal to a preset threshold value, each image frame in the image frame sequence is sequentially processed through the steps of the method of the embodiments of the disclosure, to obtain a processed image frame sequence. A second video stream formed by the processed image frame sequence is output and/or displayed.

In the implementation, the image frame in the video stream acquired by the video acquisition device may be processed. As an example, the device for image processing may store the preset threshold value. In the case that the resolution of the image frame sequence in the first video stream acquired by the video acquisition device is smaller than or equal to the preset threshold value, each image frame in the image frame sequence may be processed based on the steps in the method for image processing of the embodiments of the disclosure, to obtain a plurality of corresponding processed image frames to form the processed image frame sequence. Furthermore, the second video stream formed by the processed image frame sequence may be output and/or displayed. The quality of the image frames in the video data is improved, and effects of video restoration and video super-resolution are achieved.

In an optional implementation, the method for image processing is implemented based on a neural network. The neural network is obtained by training with a dataset including multiple sample image frame pairs. Each of the sample image frame pairs includes a first sample image frame and a second sample image frames corresponding to the first sample image frame. A resolution of the first sample image frame is lower than a resolution of the second sample image frame.

Through the trained neural network, an image processing process including inputting the image frame sequence, outputting the fused information and acquiring the processed image frame is completed. The neural network in the embodiments of the disclosure does not require additional manual labeling, and only requires the sample image frame pairs. During training, training may be implemented based on the first sample image frames targeted at the second sample image frames. For example, the training dataset may include a pair of relatively high-definition and low-definition sample image frames, or a pair of blurred and non-blurred sample image frames, or other pairs. The sample image frame pairs are controllable during data acquisition, and the embodiments of the disclosure do not set limitations herein. Optionally, the dataset may be a REDS dataset, a vimeo90 dataset, or other public datasets.

In embodiments of the disclosure, a unified framework capable of effectively solving multiple problems in video restoration, including, but not limited to, video super-resolution, video deblurring, video denoising and the like is provided.

As an example, the schematic diagram of a video restoration framework in FIG. 5 may be referred to. As illustrated in FIG. 5, for an image frame sequence in video data to be processed, image processing is implemented through a neural network. With video super-resolution as an example, video super-resolution usually includes: acquiring a plurality of input low-resolution frames, obtaining a series of image features of the plurality of low-resolution frames, and generating a plurality of high-resolution frames for output. For example, 2N+1 low-resolution frames may be input to generate high-resolution frames for output, N being a positive integer. In the drawing, three adjacent frames t−1, t and t+1 are input, are deblurred by a deblurring module at first, then are sequentially input to the PCD alignment module and the TSA fusion module to execute the method for image processing in the embodiments of the disclosure. Namely, multi-frame alignment and fusion is performed on each frame with the adjacent frames, to finally obtain fused information. Then the fused information is input to a reconstruction module to acquire processed image frames according to the fused information, and an upsampling operation is executed at the end of the network to enlarge a space size. Finally, a predicted image residual is added to an image obtained by directly upsampling the original image frame, so that a high-resolution frame may be obtained. Like an existing manner image/video restoration processing, the addition is intended for learning the image residual, so as to accelerate the convergence of training and improve the effect of training.

For another task with a high-resolution input, for example, video deblurring, subsampling convolution is performed on an input frame by use of a strided convolution layer at first, and then most of calculation is implemented in a low-resolution space, so that the calculation cost is greatly reduced. Finally, a feature may be adjusted back to the resolution of the original input by upsampling. Before the alignment module, a pre-deblurring module may be used to preprocess a blurred input and improve the accuracy of alignment.

The method for image processing disclosed in the embodiments of the disclosure is generic, may be applied to many image processing scenarios such as alignment processing of a facial image, and may also be combined with other technologies involving video processing and image processing, and the embodiments of the disclosure do not set limitations herein.

It can be understood by those skilled in the art that, in the above method of the detailed description, the sequence in which various steps are drafted does not mean a strict sequence of execution and is not intended to form any limitation to the implementation. A particular sequence of executing various steps should be determined by functions and probable internal logic thereof.

The method for image processing disclosed in the embodiments of the disclosure may form an enhanced DCN-based video restoration system, including the abovementioned two core modules. That is, a unified framework capable of effectively solving multiple problems in video restoration, including, but not limited to, processing such as video super-resolution, video deblurring and video denoising is provided.

According to the embodiments of the disclosure, each video frame in the acquired video sequence is subsampled to obtain an image frame sequence. The image frame sequence is acquired, the image frame sequence including an image frame to be processed and one or more image frames adjacent to the image frame to be processed. Image alignment is performed on the image frame to be processed and each of image frames in the image frame sequence to obtain a plurality of pieces of aligned feature data. A plurality of similarity features, each between a respective one of the plurality of pieces of aligned feature data and aligned feature data corresponding to the image frame to be processed are determined based on the plurality of pieces of aligned feature data. Then the weight information of each of the plurality of pieces of aligned feature data is determined by a preset activation function and the plurality of similarity features, each between a respective one of the plurality of pieces of aligned feature data and the aligned feature data corresponding to the image frame to be processed. The plurality of pieces of aligned feature data are fused by a fusion convolutional network according to the weight information of each of the plurality of pieces of aligned feature data, to obtain the fused information of the image frame sequence. Then, spatial feature data is generated based on the fused information of the image frame sequence; and the spatial feature data is modulated based on spatial attention information of each element in the spatial feature data to obtain modulated fused information. The modulated fused information is configured to acquire the processed image frame corresponding to the image frame to be processed.

In the embodiments of the disclosure, the alignment operation is implemented based on the pyramid structure, cascading and deformable convolution. The whole alignment module may perform alignment by implicitly estimating motions based on the DCN. By means of the pyramid structure, coarse alignment is performed on an input of a small size at first, and then a preliminary result is input to a layer of a larger scale for adjustment. In such a manner, alignment challenges brought by complex and excessive motions may be effectively solved. By means of a cascaded structure, the preliminary result is further finely tuned such that the alignment result may be more accurate. Using the alignment module for multi-frame alignment may effectively solve the alignment problems in video restoration, particularly in the case that there is a complex motion or a motion with a relatively large magnitude, occlusion, blur or the like in an input frame.

The fusion operation is based on temporal and spatial attention mechanisms. Considering that a series of input frames include different information and also have different conditions of motion conditions, blur and alignment, the temporal attention mechanism may endow information of different regions of different frames with different importance. The spatial attention mechanism may further dig out relationships in space and between feature channels to improve the effect. Using the fusion module for multi-frame fusion after alignment may effectively solve problems in multi-frame fusion, dig out different information contained in different frames and correct imperfect alignment occurred in the alignment stage.

In summary, according to the method for image processing in the embodiments of the disclosure, the quality of multi-frame alignment and fusion in image processing may be improved, and a display effect of a processed image may be increased. Moreover, image restoration and video restoration may be realized, and the accuracy of restoration and a restoration effect are improved.

The solutions of the embodiments of the disclosure are introduced mainly from the view of a method execution process. It can be understood that, for realizing the functions, the device for image processing includes corresponding hardware structures and/or software modules executing the various functions. Those skilled in the art may easily realize that the units and algorithm steps of each example described in combination with the embodiments disclosed in the disclosure may be implemented by hardware or a combination of the hardware and computer software in the disclosure. Whether a certain function is executed by the hardware or in a manner of driving the hardware by the computer software depends on specific application and design constraints of the technical solutions. Professionals may realize the described functions for specific applications by use of different methods, but such realization shall fall within the scope of the disclosure.

According to the embodiments of the disclosure, functional units of the device for image processing may be divided according to the abovementioned method example. For example, each functional unit may be divided correspondingly to each function, or two or more functions may also be integrated into a processing unit. The integrated unit may be implemented in a hardware form and may also be implemented in form of software functional unit. It is to be noted that division of the units in the embodiments of the disclosure is schematic and only logical function division, and another division manner may be used during practical implementation.

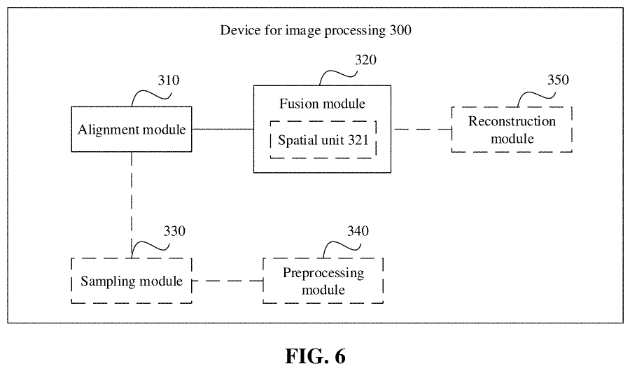

Referring to FIG. 6, FIG. 6 illustrates a schematic structural diagram of a device for image processing according to embodiments of the disclosure. As illustrated in FIG. 6, the device for image processing 300 includes an alignment module 310 and a fusion module 320.

The alignment module 310 is configured to acquire an image frame sequence, comprising an image frame to be processed and one or more image frames adjacent to the image frame to be processed, and perform image alignment on the image frame to be processed and each of image frames in the image frame sequence to obtain a plurality of pieces of aligned feature data.

The fusion module 320 is configured to determine, based on the plurality of pieces of aligned feature data, a plurality of similarity features, each between a respective one of the plurality of pieces of aligned feature data and aligned feature data corresponding to the image frame to be processed, and determine, based on the plurality of similarity features, weight information of each of the plurality of pieces of aligned feature data.

The fusion module 320 is further configured to fuse the plurality of pieces of aligned feature data according to the weight information of each of the plurality of pieces of aligned feature data, to obtain fused information of the image frame sequence, the fused information being configured to acquire a processed image frame corresponding to the image frame to be processed.

In an optional embodiment of the disclosure, the alignment module 310 is configured to: perform, based on a first image feature set and one or more second image feature sets, image alignment on the image frame to be processed and each of the image frames in the image frame sequence to obtain the plurality of pieces of aligned feature data. The first image feature set includes at least one piece of feature data of the image frame to be processed, and each of the at least one piece of feature data in the first image feature set has a respective different scale. Each of the one or more second image feature sets includes at least one piece of feature data of a respective image frame in the image frame sequence, and each of the at least one piece of feature data in the second image feature set has a respective different scale.

In an optional implementation of the disclosure, the alignment module 310 is configured to perform the following actions: action a), acquiring first feature data of a smallest scale in the first image feature set, and acquiring second feature data, of the same scale as the first feature data, in one of the one or more second image feature sets; action b), performing image alignment on the first feature data and the second feature data to obtain first aligned feature data; action c), acquiring third feature data of a second smallest scale in the first image feature set, and acquiring fourth feature data, of the same scale as the third feature data, in the second image feature set; action d), performing upsampling convolution on the first aligned feature data to obtain the first aligned feature data having the same scale as that of the third feature data; action e), performing, based on the first aligned feature data having subjected to the upsampling convolution, image alignment on the third feature data and the fourth feature data to obtain second aligned feature data; action f), executing the actions a)-e) in a small-to-large order of scales until a piece of aligned feature data of the same scale as the image frame to be processed is obtained; and action g), executing the actions a)-f) based on all the second image feature sets to obtain the plurality of pieces of aligned feature data.

In an optional embodiment of the disclosure, the alignment module 310 is further configured to: after the plurality of pieces of aligned feature data are obtained, adjust each of the plurality of pieces of aligned feature data based on a deformable convolutional network (DCN) to obtain a plurality pieces of adjusted aligned feature data.

In an optional embodiment of the disclosure, the fusion module 320 is configured to: execute a dot product operation on each of the plurality of pieces of aligned feature data and the aligned feature data corresponding to the image frame to be processed, to determine the plurality of similarity features, each between a respective one of the plurality of pieces of aligned feature data and the aligned feature data corresponding to the image frame to be processed.

In an optional embodiment of the disclosure, the fusion module 320 is further configured to: determine the weight information of each of the plurality of pieces of aligned feature data by a preset activation function and the plurality of similarity features, each between a respective one of the plurality of pieces of aligned feature data and the aligned feature data corresponding to the image frame to be processed.

In an optional embodiment of the disclosure, the fusion module 320 is configured to: fuse, by a fusion convolutional network, the plurality of pieces of aligned feature data according to the weight information of each of the plurality of pieces of aligned feature data, to obtain the fused information of the image frame sequence.

In an optional embodiment of the disclosure, the fusion module 320 is configured to: multiply, through element-wise multiplication, each of the plurality of pieces of aligned feature data by a respective piece of weight information, to obtain a plurality pieces of modulated feature data, each for a respective one of the plurality of pieces of aligned feature data; and fuse, by the fusion convolutional network, the plurality pieces of modulated feature data to obtain the fused information of the image frame sequence.

In an optional embodiment of the disclosure, the fusion module 320 includes a spatial unit 321, configured to: generate spatial feature data based on the fused information of the image frame sequence, after the fusion module 320 fuses, by the fusion convolutional network, the plurality of pieces of aligned feature data according to the weight information of each of the plurality of pieces of aligned feature data, to obtain the fused information of the image frame sequence; and modulate the spatial feature data based on spatial attention information of each element in the spatial feature data to obtain modulated fused information, the modulated fused information being configured to acquire the processed image frame corresponding to the image frame to be processed.

In an optional embodiment of the disclosure, the spatial unit 321 is configured to: modulate, by element-wise multiplication and addition, each element in the spatial feature data according to respective spatial attention information of the element in the spatial feature data, to obtain the modulated fused information.

In an optional embodiment of the disclosure, a neural network is deployed in the device for image processing 300. The neural network is obtained by training with a dataset comprising a plurality of sample image frame pairs, each of the sample image frame pairs comprises a first sample image frame and a second sample image frame corresponding to the first sample image frame, and a resolution of the first sample image frame is lower than a resolution of the second sample image frame.

In an optional embodiment of the disclosure, the device for image processing 300 further includes a sampling module 330, configured to: before the image frame sequence is acquired, subsample each video frame in an acquired video sequence to obtain the image frame sequence.

In an optional embodiment of the disclosure, the device for image processing 300 further includes a preprocessing module 340, configured to: before image alignment is performed on the image frame to be processed and each of the image frames in the image frame sequence, perform deblurring on the image frames in the image frame sequence.

In an optional embodiment of the disclosure, the device for image processing 300 further includes a reconstruction module 350, configured to: acquire, according to the fused information of the image frame sequence, the processed image frame corresponding to the image frame to be processed.

The device for image processing 300 in the embodiments of the disclosure may be used to implement the method for image processing in the embodiments in FIG. 1 and FIG. 2.

The device for image processing 300 illustrated in FIG. 6 is implemented. The device for image processing 300 may be configured to: acquire the image frame sequence including the image frame to be processed and the one or more image frames adjacent to the image frame to be processed, and perform image alignment on the image frame to be processed and each of image frames in the image frame sequence to obtain a plurality of pieces of aligned feature data; then determine, based on the plurality of pieces of aligned feature data, a plurality of similarity features, each between a respective one of the plurality of pieces of aligned feature data and aligned feature data corresponding to the image frame to be processed, and determine, based on the plurality of similarity features, weight information of each of the plurality of pieces of aligned feature data; and fuse, the plurality of pieces of aligned feature data according to the weight information of each of the plurality of pieces of aligned feature data. In such a manner, the fused information of the image frame sequence can be obtained. The fused information may be configured to acquire a processed image frame corresponding to the image frame to be processed. Therefore, the quality of multi-frame alignment and fusion in image processing may be greatly improved, and a display effect of the processed image may be improved; and moreover, image restoration and video restoration may be realized, and the accuracy of restoration and a restoration effect are enhanced.

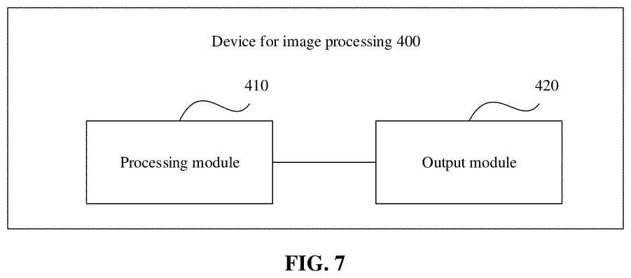

Referring to FIG. 7, FIG. 7 illustrates a schematic structural diagram of another device for image processing according to embodiments of the disclosure. The device for image processing 400 includes a processing module 410 and an output module 420.

The processing module 410 is configured to: in response to that a resolution of an image frame sequence in a first video stream acquired by a video acquisition device is less than or equal to a preset threshold value, sequentially carry out any step in the method according to the embodiments illustrated in FIG. 1 and/or FIG. 2 to process each image frame in the image frame sequence, to obtain a processed image frame sequence.

The output module 420 is configured to output and/or display a second video stream formed by the processed image frame sequence.

The device for image processing 400 illustrated in FIG. 7 is implemented, The device for image processing 400 may be configured to: acquire the image frame sequence including the image frame to be processed and the one or more image frames adjacent to the image frame to be processed, and perform image alignment on the image frame to be processed and each of image frames in the image frame sequence to obtain a plurality of pieces of aligned feature data; then determine, based on the plurality of pieces of aligned feature data, a plurality of similarity features, each between a respective one of the plurality of pieces of aligned feature data and aligned feature data corresponding to the image frame to be processed, and determine, based on the plurality of similarity features, weight information of each of the plurality of pieces of aligned feature data; and fuse, the plurality of pieces of aligned feature data according to the weight information of each of the plurality of pieces of aligned feature data. In such a manner, the fused information of the image frame sequence can be obtained. The fused information may be configured to acquire a processed image frame corresponding to the image frame to be processed. Therefore, the quality of multi-frame alignment and fusion in image processing may be greatly improved, and a display effect of the processed image may be improved; and moreover, image restoration and video restoration may be realized, and the accuracy of restoration and a restoration effect are enhanced.

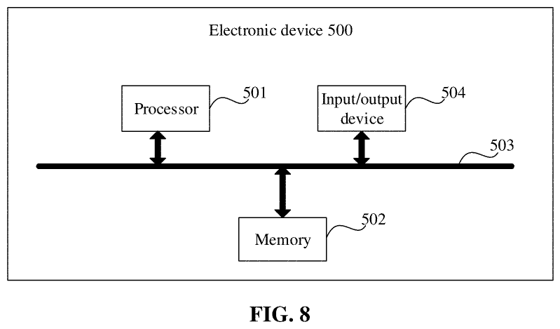

Referring to FIG. 8, FIG. 8 illustrates a schematic structural diagram of an electronic device according to embodiments of the disclosure. As illustrated in FIG. 8, the electronic device 500 includes a processor 501 and a memory 502. The electronic device 500 may further include a bus 503. The processor 501 and the memory 502 may be connected with each other through the bus 503. The bus 503 may be a Peripheral Component Interconnect (PCI) bus, an Extended Industry Standard Architecture (EISA) bus, or other buses. The bus 503 may be divided into an address bus, a data bus, a control bus and the like. For convenient representation, only one bold line is used to represent the bus in FIG. 8, but it is not indicated that there is only one bus or one type of bus. The electronic device 500 may further include an input/output device 504, and the input/output device 504 may include a display screen, for example, a liquid crystal display screen. The memory 502 is configured to store a computer program. The processor 501 is configured to call the computer program stored in the memory 502 to execute part or all of the steps of the method mentioned in the embodiments in FIG. 1 and FIG. 2.

The electronic device 500 illustrated in FIG. 8 is implemented. The electronic device 500 may be configured to: acquire the image frame sequence including the image frame to be processed and the one or more image frames adjacent to the image frame to be processed, and perform image alignment on the image frame to be processed and each of image frames in the image frame sequence to obtain a plurality of pieces of aligned feature data; then determine, based on the plurality of pieces of aligned feature data, a plurality of similarity features, each between a respective one of the plurality of pieces of aligned feature data and aligned feature data corresponding to the image frame to be processed, and determine, based on the plurality of similarity features, weight information of each of the plurality of pieces of aligned feature data; and fuse, the plurality of pieces of aligned feature data according to the weight information of each of the plurality of pieces of aligned feature data. In such a manner, the fused information of the image frame sequence can be obtained. The fused information may be configured to acquire a processed image frame corresponding to the image frame to be processed. Therefore, the quality of multi-frame alignment and fusion in image processing may be greatly improved, and a display effect of the processed image may be improved; and moreover, image restoration and video restoration may be realized, and the accuracy of restoration and a restoration effect are enhanced.

In embodiments of the disclosure, also provided is a computer storage medium, which is configured to store a computer program, the computer program enabling a computer to execute part or all of the steps of any method for image processing disclosed in the method embodiments above.

It is to be noted that, for simple description, each method embodiment is expressed as a combination of a series of actions. However, those skilled in the art should know that the disclose is not limited by an action sequence described herein because some steps may be executed in another sequence or simultaneously according to the disclosure. Secondly, those skilled in the art should also know that the embodiments described in the disclosure are all preferred embodiments and actions and modules involved therein are not always necessary to the disclosure.

The abovementioned embodiments are described with different emphases, and undetailed parts in a certain embodiment may refer to related description in the other embodiments.

In some embodiments provided in the disclosure, it is to be understood that the disclosed device may be implemented in other ways. For example, the device embodiments described above are only schematic, and for example, division of the units is only division of logical functions, and other division manners may be used during practical implementation. For example, a plurality of units or components may be combined or integrated into another system, or some features may be neglected or not executed. In addition, coupling or direct coupling or communication connection that are displayed or discussed may be indirect coupling or communication connection of devices or units implemented through some interfaces, and may be electrical or in other forms.

The units (modules) described as separate parts may or may not be physically separated. Parts displayed as units may or may not be physical units, and may be located in the same place or may also be distributed to a plurality of network units. Part or all of the units may be selected to achieve the purpose of the solutions of the embodiments according to a practical requirement.

In addition, various functional units in embodiments of the disclosure may be integrated into a processing unit. Each unit may physically exist independently, or two or more units may be integrated into one unit. The integrated unit may be implemented in a hardware form , or may be implemented in form of software functional unit.

When implemented in form of software functional unit and sold or used as an independent product, the integrated unit may be stored in a computer-readable memory. Based on such an understanding, the technical solutions of the disclosure substantially, or in part making contribution to the related art, or all or part of the technical solutions may be embodied in form of software product. The computer software product is stored in a memory, including a plurality of instructions configured to enable a computer device (which may be a personal computer, a server, a network device or the like) to execute all or part of the steps of the method in various embodiments of the disclosure. The abovementioned memory includes various media capable of storing program codes such as a USB flash disk, a Read-Only Memory (ROM), a Random Access Memory (RAM), a mobile hard disk, a magnetic disk or an optical disk.

Those of ordinary skill in the art can understand that all or part of the steps in various methods of the embodiments may be completed by a program instructing related hardware. The program may be stored in a computer-readable memory, and the memory may include a flash disk, a ROM, a RAM, a magnetic disk, an optical disk or the like.

The embodiments of the disclosure are introduced above in detail. The principle and implementations of the disclosure are elaborated with particular examples in the disclosure. The description made to the embodiments only serve to help understanding the method of the disclosure and the core concept thereof. In addition, those of ordinary skill in the art may make variations to the particular implementations and the application scope according to the concept of the disclosure. From the above, the contents of the specification should not be construed limiting the disclosure.

1. A method for image processing, comprising:
acquiring an image frame sequence, comprising an image frame to be processed and one or more image frames adjacent to the image frame to be processed, and performing image alignment on the image frame to be processed and each of image frames in the image frame sequence to obtain a plurality of pieces of aligned feature data;
determining, based on the plurality of pieces of aligned feature data, a plurality of similarity features, each between a respective one of the plurality of pieces of aligned feature data and aligned feature data corresponding to the image frame to be processed, and determining, based on the plurality of similarity features, weight information of each of the plurality of pieces of aligned feature data; and
fusing the plurality of pieces of aligned feature data according to the weight information of each of the plurality of pieces of aligned feature data, to obtain fused information of the image frame sequence, the fused information being configured to acquire a processed image frame corresponding to the image frame to be processed.

2. The method for image processing of claim 1, wherein performing image alignment on the image frame to be processed and each of the image frames in the image frame sequence to obtain the plurality of pieces of aligned feature data comprises:
performing, based on a first image feature set and one or more second image feature sets, image alignment on the image frame to be processed and each of the image frames in the image frame sequence to obtain the plurality of pieces of aligned feature data, wherein:
the first image feature set comprises at least one piece of feature data of the image frame to be processed, and each of the at least one piece of feature data in the first image feature set has a respective different scale; and
each of the one or more second image feature sets comprises at least one piece of feature data of a respective image frame in the image frame sequence, and each of the at least one piece of feature data in the second image feature set has a respective different scale.

3. The method for image processing of claim 2, wherein performing, based on the first image feature set and the one or more second image feature sets, image alignment on the image frame to be processed and each of the image frames in the image frame sequence to obtain the plurality of pieces of aligned feature data comprises:
action a), acquiring first feature data of a smallest scale in the first image feature set, and acquiring second feature data, of the same scale as the first feature data, in one of the one or more second image feature sets;
action b), performing image alignment on the first feature data and the second feature data to obtain first aligned feature data;
action c), acquiring third feature data of a second smallest scale in the first image feature set, and acquiring fourth feature data, of the same scale as the third feature data, in the second image feature set;
action d), performing upsampling convolution on the first aligned feature data to obtain the first aligned feature data having the same scale as that of the third feature data;
action e), performing, based on the first aligned feature data having subjected to the upsampling convolution, image alignment on the third feature data and the fourth feature data to obtain second aligned feature data;
action f), executing the actions a) to e) in a small-to-large order of scales until a piece of aligned feature data of the same scale as the image frame to be processed is obtained; and
action g), executing the actions a)-f) based on all the second image feature sets to obtain the plurality of pieces of aligned feature data.

4. The method for image processing of claim 3, wherein after obtaining the plurality of pieces of aligned feature data, the method further comprises:
adjusting each of the plurality of pieces of aligned feature data based on a deformable convolutional network (DCN) to obtain a plurality pieces of adjusted aligned feature data.

5. The method for image processing of claim 1, wherein determining, based on the plurality of pieces of aligned feature data, the plurality of similarity features, each between a respective one of the plurality of pieces of aligned feature data and the aligned feature data corresponding to the image frame to be processed comprises:
executing a dot product operation on each of the plurality of pieces of aligned feature data and the aligned feature data corresponding to the image frame to be processed, to determine the plurality of similarity features, each between a respective one of the plurality of pieces of aligned feature data and the aligned feature data corresponding to the image frame to be processed.

6. The method for image processing of claim 5, wherein determining, based on the plurality of similarity features, the weight information of each of the plurality of pieces of aligned feature data comprises:
determining the weight information of each of the plurality of pieces of aligned feature data by a preset activation function and the plurality of similarity features, each between a respective one of the plurality of pieces of aligned feature data and the aligned feature data corresponding to the image frame to be processed.

7. The method for image processing of claim 1, wherein fusing the plurality of pieces of aligned feature data according to the weight information of each of the plurality of pieces of aligned feature data, to obtain the fused information of the image frame sequence comprises:
fusing, by a fusion convolutional network, the plurality of pieces of aligned feature data according to the weight information of each of the plurality of pieces of aligned feature data, to obtain the fused information of the image frame sequence.

8. The method for image processing of claim 7, wherein fusing, by the fusion convolutional network, the plurality of pieces of aligned feature data according to the weight information of each of the plurality of pieces of aligned feature data, to obtain the fused information of the image frame sequence comprises:
multiplying, through element-wise multiplication, each of the plurality of pieces of aligned feature data by a respective piece of weight information, to obtain a plurality pieces of modulated feature data, each for a respective one of the plurality of pieces of aligned feature data; and
fusing, by the fusion convolutional network, the plurality pieces of modulated feature data to obtain the fused information of the image frame sequence.

9. The method for image processing of claim 7, wherein after fusing, by the fusion convolutional network, the plurality of pieces of aligned feature data according to the weight information of each of the plurality of pieces of aligned feature data, to obtain the fused information of the image frame sequence, the method further comprises:
generating spatial feature data based on the fused information of the image frame sequence; and
modulating the spatial feature data based on spatial attention information of each element in the spatial feature data to obtain modulated fused information, the modulated fused information being configured to acquire the processed image frame corresponding to the image frame to be processed.

10. The method for image processing of claim 9, wherein modulating the spatial feature data based on the spatial attention information of each element in the spatial feature data to obtain the modulated fused information comprises:
modulating, by element-wise multiplication and addition, each element in the spatial feature data according to respective spatial attention information of the element in the spatial feature data, to obtain the modulated fused information.

11. The method for image processing of claim 1, wherein the method for image processing is implemented based on a neural network; and
the neural network is obtained by training with a dataset comprising a plurality of sample image frame pairs, each of the sample image frame pairs comprises a first sample image frame and a second sample image frame corresponding to the first sample image frame, and a resolution of the first sample image frame is lower than a resolution of the second sample image frame.

12. The method for image processing of claim 1, wherein before acquiring the image frame sequence, the method further comprises:
subsampling each video frame in an acquired video sequence to obtain the image frame sequence.

13. The method for image processing of claim 1, wherein before performing image alignment on the image frame to be processed and each of the image frames in the image frame sequence, the method further comprises:
performing deblurring on the image frames in the image frame sequence.

14. The method for image processing of claim 1, further comprising:
acquiring, according to the fused information of the image frame sequence, the processed image frame corresponding to the image frame to be processed.

15. A method for image processing, comprising:
in response to that a resolution of an image frame sequence in a first video stream acquired by a video acquisition device is less than or equal to a preset threshold value, sequentially processing each image frame in the image frame sequence through the method of claim 1 to obtain a processed image frame sequence; and
performing at least one of: outputting or displaying a second video stream formed by the processed image frame sequence.

16. An electronic device, comprising a processor and a memory, wherein the memory is configured to store instructions which, when being executed by the processor, cause the processor to carry out the following:
acquiring an image frame sequence, comprising an image frame to be processed and one or more image frames adjacent to the image frame to be processed, and performing image alignment on the image frame to be processed and each of image frames in the image frame sequence to obtain a plurality of pieces of aligned feature data;
determining, based on the plurality of pieces of aligned feature data, a plurality of similarity features, each between a respective one of the plurality of pieces of aligned feature data and aligned feature data corresponding to the image frame to be processed, and determining, based on the plurality of similarity features, weight information of each of the plurality of pieces of aligned feature data; and
fusing the plurality of pieces of aligned feature data according to the weight information of each of the plurality of pieces of aligned feature data, to obtain fused information of the image frame sequence, the fused information being configured to acquire a processed image frame corresponding to the image frame to be processed.

17. The electronic device of claim 16, wherein in performing image alignment on the image frame to be processed and each of the image frames in the image frame sequence to obtain the plurality of pieces of aligned feature data, the processor is caused to carry out the following:
performing, based on a first image feature set and one or more second image feature sets, image alignment on the image frame to be processed and each of the image frames in the image frame sequence to obtain the plurality of pieces of aligned feature data, wherein:
the first image feature set comprises at least one piece of feature data of the image frame to be processed, and each of the at least one piece of feature data in the first image feature set has a respective different scale; and
each of the one or more second image feature sets comprises at least one piece of feature data of a respective image frame in the image frame sequence, and each of the at least one piece of feature data in the second image feature set has a respective different scale.

18. The electronic device of claim 17, wherein in performing, based on the first image feature set and the one or more second image feature sets, image alignment on the image frame to be processed and each of the image frames in the image frame sequence to obtain the plurality of pieces of aligned feature data, the processor is caused to perform the following:
action a), acquiring first feature data of a smallest scale in the first image feature set, and acquiring second feature data, of the same scale as the first feature data, in one of the one or more second image feature sets;
action b), performing image alignment on the first feature data and the second feature data to obtain first aligned feature data;
action c), acquiring third feature data of a second smallest scale in the first image feature set, and acquiring fourth feature data, of the same scale as the third feature data, in the second image feature set;
action d), performing upsampling convolution on the first aligned feature data to obtain the first aligned feature data having the same scale as that of the third feature data;
action e), performing, based on the first aligned feature data having subjected to the upsampling convolution, image alignment on the third feature data and the fourth feature data to obtain second aligned feature data;
action f), executing the actions a) to e) in a small-to-large order of scales until a piece of aligned feature data of the same scale as the image frame to be processed is obtained; and
action g), executing the actions a)-f) based on all the second image feature sets to obtain the plurality of pieces of aligned feature data.

19. The electronic device of claim 18, wherein the processor is caused to carry out the following:
after obtaining the plurality of pieces of aligned feature data, adjusting each of the plurality of pieces of aligned feature data based on a deformable convolutional network (DCN) to obtain a plurality pieces of adjusted aligned feature data.

20. A non-transitory computer-readable storage medium, configured to store instructions which, when being executed by a processor, cause the processor to carry out the following:
acquiring an image frame sequence, comprising an image frame to be processed and one or more image frames adjacent to the image frame to be processed, and performing image alignment on the image frame to be processed and each of image frames in the image frame sequence to obtain a plurality of pieces of aligned feature data;
determining, based on the plurality of pieces of aligned feature data, a plurality of similarity features, each between a respective one of the plurality of pieces of aligned feature data and aligned feature data corresponding to the image frame to be processed, and determining, based on the plurality of similarity features, weight information of each of the plurality of pieces of aligned feature data; and
fusing the plurality of pieces of aligned feature data according to the weight information of each of the plurality of pieces of aligned feature data, to obtain fused information of the image frame sequence, the fused information being configured to acquire a processed image frame corresponding to the image frame to be processed.
